(19) United States
(12) Patent Application Publication
(10) Pub. No.: US 2022/0198749 A1
(43) Pub. Date: Jun. 23, 2022

(54) SYSTEM AND METHOD FOR MONITORING FOREST GAP USING LIDAR SURVEY DATA

(71) Applicant: SEOUL NATIONAL UNIVERSITY R&DB FOUNDATION, Seoul (KR)

(72) Inventors: Dong Kun LEE, Seoul (KR); Young Keun SONG, Seoul (KR); Hee Joon CHOI, Seoul (KR)

(21) Appl. No.: 17/603,608

(22) PCT Filed: Jun. 24, 2019
(86) PCT No.: PCT/KR2019/007573

§ 371 Date: Oct. 14, 2021

(30) Foreign Application Priority Data
Apr. 19, 2019 (KR) 10-2019-0046295

(51) Int. Cl. G06T 17/05; G06T 7/60; G06K 9/62

(52) U.S. Cl. CPC G06T 17/05; G06T 7/60; G06K 9/6267; G01S 17/89; G06T 2207/30188; G06T 2210/56; G06T 2207/10028

(57) ABSTRACT

The present invention is intended for providing a system and method of detecting a forest gap occurring in a city and monitoring a change in the forest gap.

Thus, disclosed is the present invention comprising: a data input unit configured to input and receive LiDAR survey data; a pre-processing unit configured to remove a noise from the LiDAR survey data and classify each of point cloud data; a modeling unit configured to generate a canopy height model with respect to the point cloud data classified as the trees; a forest gap classification unit; and a forest gap change measurement unit.

### TECHNICAL FIELD

The present invention relates to a method and system which are capable of monitoring a change in a forest gap occurring in a city using LiDAR (Light Detection And Ranging) survey data.

### BACKGROUND ART

A disturbance is deviating from the scope of a usual change in an ecological system, and the disturbance occurring in a forest is one of main factors to decide a structure and function of forest vegetation. In the forest, a gap, which is an open space, occurs due to the disturbance, and a vacant space occurs vertically as well as horizontally when trees, which form a whole appearance of the top of the forest, are dead, so an open canopy or a forest gap is formed.

A forest gap may be classified into a naturally generated forest gap and an artificially generated forest gap. Furthermore, the forest gap may be regarded as a space in which the forest is opened because a vacant space appears when the forest gap is viewed from the sky, and an area, which is not a forest gap, may be regarded as a space in which the forest is closed because no vacant space appears.

The naturally generated forest gap is generated due to a reason why trees are dead, or roots of the trees are taken out, and so on, but the forest gap may disappear due to a reason why the structure of a canopy, which forms the top of trees with branches and leaves, is variously changed by growth of the trees with the lapse of time, and a reason why an open space in the forest is closed.

However, in the forest gap artificially generated according to a change in the use of land, and so on, or a disturbance area, no structural difference of the canopy occurs because the trees have not grown in spite of the lapse of time, so movement of the forest hardly changes.

Even though a forest formed in a city is advantageous in that it increases variety of the species of living things, purifies air, and improves the health of citizens, the forest gap can occur due to the disturbance occurring in the forest in the process of using the land or carrying out the development project of a city. In the case that no measures for such a forest gap is taken at an appropriate time, there is high possibility that the forest gap continuously remains as an open space, and thus the forest gap can have a bad influence on a city ecosystem due to a reason why it becomes a route through which an introduced species infiltrates, and so on.

In order to observe a change in the forest gap occurring in the city and classify a canopy, a spot survey can be carried out, or an air photograph can be used. However, observing the change in the forest gap through the spot survey requires a lot of time and effort, and there is a limit to a survey method based on sampling, which shows that it is difficult to assume a change in forest gaps of the whole city.

Furthermore, in the case that the forest gap is investigated using a high-resolution air photograph, an error can occur due to a shadow generated according to altitude of the sun, flight attitude, a height of trees, and so on, and since the air photograph is a two-dimensional datum, it is difficult to correctly understand the change in the forest gap and the kind of the canopy.

Meanwhile, LiDAR (LiDAR, Light Detection And Ranging) device is a device that calculates the three dimensional coordinates of a target (a position on an axis X, an axis Y, and an axis Z) by calculating time required for a reflected light to return to a sensor after a laser pulse has been emitted to the target.

Since the LiDAR (LiDAR, Light Detection And Ranging) device uses an optical pulse having a short wavelength, it may obtain information by dividing a space into small units, thereby having resolution and accuracy of a considerably high level. Furthermore, it is advantages in that a wide field of view FOV is provided because the optical pulse is emitted in all directions of 360 degrees, and no capacity decreases in spite of weather conditions such as rain, snow, a mist, and so on.

This LiDAR device has been installed in an airplane, or a small-sized mobile LiDAR device has been directly used in an investigation area so that information on the lay of the land and forest vegetation could be measured, but a system and method of monitoring a change in a forest gap occurring in the forest of a city using measured LiDAR survey data have not been disclosed.

### DETAILED DESCRIPTION OF THE INVENTION

### Technical Problem

An object of the present invention is to provide a system and method of detecting a forest gap occurring in a city and monitoring a change in the forest gap.

### Solution for Solving the Problem

In order to achieve the object as described above, the present invention provides a forest gap monitoring system comprising: a data input unit configured to input and receive LiDAR survey data including point cloud data; a pre-processing unit configured to remove low and high point cloud data from the LiDAR survey data and classify the point cloud data into the ground, buildings, trees, vehicles, and the other objects on the ground; a modeling unit configured to generate a digital surface model DSM and a digital terrain model DTM according to each point cloud datum and generate a canopy height model CHM by subtracting a height of the digital terrain model DTM from a height of the digital surface model DSM with respect to the point cloud data classified as the trees; a forest gap classification unit configured to classify a region as a forest gap in the case that a total area of the region corresponding to the adjacent point cloud data, in which a height of the canopy height model CHM is less than a first height H1, is more than a first area A1, and classify the region as a closed canopy CC in the case that the total area of the region, in which the height of the canopy height model is more than the first height, is less than the first area; and a forest gap change measurement unit configured to classify the region as a closed forest gap CG in the case that the region classified as the forest gap FG changes to the closed canopy CC during a first measurement term T1, and classify the region as an existing forest gap EG in the case that the region classified as the forest gap FG remains as the forest gap FG.

The forest gap monitoring system further comprises: a canopy classification unit configured to classify a canopy as a lower canopy LC according to the each point cloud datum in the case that the height of the canopy height model CHM is less than the first height H1, and classify the canopy as a higher canopy HC in the case that the height of the canopy height model is more than the first height; a canopy change measurement unit configured to measure a change in the height of the canopy height model CHM according to the each point cloud datum during a second measurement term T2; and an area classification unit configured to classify an area as a vertical growth area VG according to the each point cloud datum in the case that the change in the height of the canopy height model has a plus value, and the height is less than a second height H2, classify the area as a lateral growth area LG in the case that the height is more than the second height H2, and classify the area as a disturbance area DA in the case that the change has a minus value.

Furthermore, the present invention provides the forest gap monitoring system wherein the first height H1 is 5 m, the first area A1 is 10 m², and the first measurement term T1 is three years.

Furthermore, the present invention provides the forest gap monitoring system wherein the second height H2 is 0.5 m, and the second measurement term T2 is three years.

According to another exemplary embodiment of the present invention, the present invention provides a forest gap monitoring method comprising: (1) inputting and receiving, by a data input unit, Lidar survey data including point cloud data; (2) removing, by a pre-processing unit, low and high point cloud data from the LiDAR survey data, and classifying the point cloud data into the ground, buildings, trees, vehicles, and the other objects on the ground; (3) generating, by a modeling unit, a digital surface model DSM and a digital terrain model DTM according to each point cloud datum, and generating a canopy height model CHM by subtracting a height of the digital terrain model DTM from a height of the digital surface model DSM with respect to the point cloud data classified as the trees; (4) classifying, by a forest gap classification unit, a region as a forest gap in the case that a total area of the region corresponding to the adjacent point cloud data, in which a height of the canopy height model is less than a first height H1, is more than a first area A1, or classifying the region as a closed canopy CC in the case that the total area of the region, in which the height of the canopy height model is more than the first height, is less than the first area; and (5) classifying, by a forest gap change measurement unit, the region as a closed forest gap CG in the case that the region classified as the forest gap FG changes to the closed canopy CC during a first measurement term T1, and classifying the region as an existing forest gap EG in the case that the region classified as the forest gap FG remains as the forest gap FG.

Furthermore, the forest gap monitoring method further comprises: (6) classifying, by a canopy classification unit, a canopy as a lower canopy LC according to each point cloud datum in the case that the height of the canopy height model CHM is less than the first height H1, or classifying the canopy as a higher canopy HC in the case that the height of the canopy height model is more than the first height; (7) measuring, by a canopy change measurement unit, a change in the height of the canopy height model CHM according to each point cloud datum during a second measurement term T2; and (8) classifying, by an area classification unit, an area as a vertical growth area VG according to each point cloud datum in the case that the change in the height of the canopy height model has a plus value and the height is less than a second height H2, classifying the area as a lateral growth area LG in the case that the height is more than the second height H2, and classifying the area as a disturbance area DA in the case that the change has a minus value.

Furthermore, the present invention provides the forest gap monitoring method wherein the first height H1 is 5 m, the first area A1 is 10 m², and the first measurement term T1 is three years.

Furthermore, the present invention provides the forest gap monitoring method wherein the second height H2 is 0.5 m, and the second measurement term T2 is three years.

### Effect of the Invention

As explained above, according to the present invention, information on the growth of a forest, and a disturbance occurring in an urban forest can be quantitatively estimated, and a change in a forest gap is automatically monitored so that information, which is helpful to establish a [symbol] policy against a disturbance area of the urban forest, can be provided.

### BRIEF DESCRIPTION OF THE DRAWINGS

FIG. 1 is a view showing the structure of a forest gap monitoring system according to the present invention.

FIG. 2A to FIG. 2C are views showing, by steps, a method of classifying a forest gap and monitoring a change in the forest gap and a canopy according to the present invention.

### BEST MODE FOR CARRYING OUT THE INVENTION

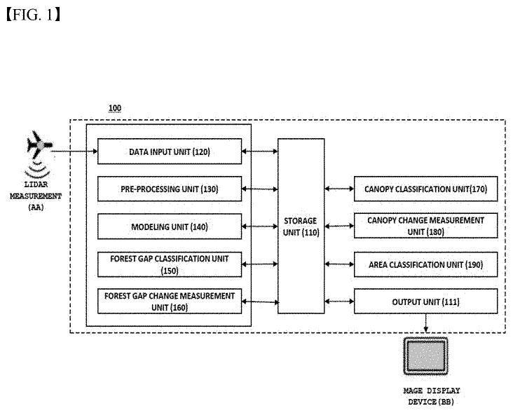

A forest gap monitoring system according to the present invention as illustrated in FIG. 1 comprises: a data input unit 120; a pre-processing unit 130; a modeling unit 140; a forest gap classification unit 150; a forest gap change measurement unit 160; a canopy classification unit 170; a canopy change measurement unit 190; and an area classification unit 180.

The data input unit 120 inputs and receives LiDAR (Light Detection And Ranging) survey data including point cloud data.

The pre-processing unit 130 removes low and high point cloud data from the LiDAR survey data and classifies the point cloud data into the ground, buildings, trees, vehicles, and the other objects on the ground.

The modeling unit 140 generates a digital surface model DSM and a digital terrain model DTM according to each point cloud datum and generates a canopy height model CHM by subtracting a height of the digital terrain model DTM from a height of the digital surface model DSM with respect to the point cloud data classified as the trees.

The forest gap classification unit 150 classifies a region as a forest gap in the case that a total area of the region corresponding to the adjacent point cloud data, in which a height of the canopy height model is less than a first height H1, is more than a first area A1, or classifies the region as a closed canopy CC in the case that the total area of the region, in which the height of the canopy height model is more than the first height, is less than the first area.

The forest gap change measurement unit classifies the region as a closed forest gap CG in the case that the region classified as the forest gap FG changes to the closed canopy CC during a first measurement term T1, and classifies the region as an existing forest gap EG in the case that the region classified as the forest gap FG remains as the forest gap FG.

The canopy classification unit 170 classifies a canopy as a lower canopy LC according to each point cloud datum in the case that the height of the canopy height model CHM is less than the first height H1, or classifies the canopy as a higher canopy HC in the case that the height of the canopy height model is more than the first height.

The canopy change measurement unit 190 measures a change in the height of the canopy height model CHM according to each point cloud datum during a second measurement term T2.

The area classification unit 180 classifies an area as a vertical growth area VG according to each point cloud datum in the case that a change in the height of the canopy height model has a plus value and the height is less than a second height H2, classifies the region as a lateral growth area LG in the case that the height is more than the second height H2, and classifies the area as a disturbance area DA in the case that the change has a minus value.

The forest gap monitoring system according to present invention comprising such constitutions can automatically classify the aspects of a change in the forest gap resulting from a change in time, thereby being capable of providing a user with information thereabout.

### MODE FOR CARRYING OUT THE INVENTION

Hereinafter, the exemplary embodiments according to the present invention will be explained in detail with reference to the drawings.

The following exemplary embodiments are examples, which are set forth to concretely illustrate the present invention, but are not to be construed as restricting or limiting the scope of a right of the present invention. Accordingly, the other embodiments, which can be easily inferred by those having ordinary skill in the art to which the present invention pertains from the detailed description of the present invention and exemplary embodiments, are construed as falling within the scope of the right of the present invention.

FIG. 1 is a view showing a structure of a forest gap monitoring system according to the present invention. The forest gap monitoring system 100 according to the present invention 100 comprises: a storage unit configured to save LiDAR survey data; a data input unit 120 configured to input and receive the LiDAR survey data; a pre-processing unit 130 configured to remove a noise from the LiDAR survey data; a modeling unit 140 configured to find out topographical information of an urban forest and calculate a height of trees formed in the urban forest; a forest gap classification unit 150 configured to determine the existence or non-existence of a forest gap; and a forest gap change measurement unit 160 configured to classify a change in the forest gap.

The data input unit 120 functions to input and receive data including topographical information and forest vegetation information of the urban forest, a survey of which is carried out by a LiDAR device at the outside of the forest gap monitoring system 100, and is able to use all data, a survey of which is carried out by a LiDAR device installed in an airplane, a mobile LiDAR device, or the other LiDAR devices.

The LiDAR device may measure a distance to reach a target by a method of using a laser pulse or a phase difference.

According to the method of using the laser pulse, the distance S to reach the target S may be calculated by dividing a value into two, wherein the value results from multiplying a turnaround time T, which is required for the laser pulse to return to the LiDAR device through reflection by the target after the laser pulse has been emitted from the LiDAR device, and a speed of light c.

According to the method of using the phase difference, in the case that the laser pulse is continuously emitted, the turnaround time T, which is required for the laser pulse to return to the LiDAR device through reflection by the target after the laser pulse has been emitted from the LiDAR device, may be calculated by dividing the ratio ϕ/2₅₂₉ of a phase change amount φ into a frequency f, and the distance S to reach the target may be calculated by application of mathematical formula 1 as described above.

After the LiDAR device has measured the distance to reach the target through the laser pulse or the phase difference, it generates point cloud data having information about a three-dimensional position (each position on an axis X, an axis Y, and an axis Z) of the target. The LiDAR survey data including the point cloud data measured and calculated by an air or mobile LiDAR device are inputted in the forest gap monitoring system 100 through the data input unit 120. Furthermore, the data input unit 120 may input and receive the LiDAR survey data by being compatible with the LiDAR device with without a relation with the kind of the LiDAR device and a size of the point cloud data generated thereby, and may save the LiDAR survey data, which have been inputted and received, in the storage unit 110 provided in the inside of the forest gap monitoring system 100.

Furthermore, after each of the LiDAR survey data saved in the storage unit 100 has been processed by the remaining constitutions including the data input unit 120, the LiDAR survey data may again be saved in the storage unit 100.

The point cloud data of the LiDAR survey data inputted through the data input unit 120 may be affected by a noise.

Representatively, as the laser pulse emitted from the LiDAR device is multi-reflected from a space among buildings and trees, the position of the target may be measured as having an altitude that is lower than a real position. This noise may be called by low point cloud data and may frequently occur in an area having a lot of forest vegetation such as buildings, trees and so on.

According to a method of recognizing a point having the lowest altitude as the ground, since the altitude of the target is measured as being lower than the ground when the low point cloud data are generated, an error, which shows that the target is recognized as the ground, and the ground is recognized as the target, may occur, so there is necessity for removing the error.

On the one hand, in the case that clouds or birds, and the other flying objects are detected by a LiDAR sensor, point cloud data may be formed at an altitude, which is high relatively to that of the other point cloud data, and are called by high point or air point cloud data.

Since the high point cloud data become a cause why an error in the height survey of buildings and trees is generated, there is necessity for removing the high point cloud data as the low point cloud data.

By inspecting the point cloud data included in the LiDAR survey data saved in the data input unit 100, the pre-processing unit 130 may remove the point cloud data because the point cloud data are regarded as low point cloud data in the case that the number P1 of the point cloud data, which are included in a first region R1 having a fixed volume at the vicinity of a first altitude El corresponding to the altitude of the ground, is less than the standard number P2 of the point cloud data used to determine existence or non-existence of the ground.

Similarly, the pre-processing unit 130 may remove the point cloud data because the point cloud data are regarded as high point cloud data in the case that the number P3 of the point cloud data included in a second region R2, in which configuration of the ground, buildings, trees and so on can be located, and which has a fixed volume at an altitude beyond a second altitude E2 corresponding to the maximum altitude, is less than the standard number P4, P5 and P6 of the point cloud data used to determine buildings, trees, vehicles, the other objects on the ground, and so on.

In the case that the number P6 of the point cloud data included in a third region R3 having a fixed volume at an altitude between the first altitude E1 and the second altitude E2 falls within an error range of the standard number P2, P4, P5 and P6 of the point cloud data used to determine buildings, trees, vehicles, the other objects on the ground, and so on, the pre-processing unit 130 may determine and classify each of the point cloud data included in the third region R3 as the ground, the buildings, the vehicles, the other objects on the ground, and so on.

The method of determining the low point cloud data or high point cloud data, or classifying the point cloud data is not limited to the method as set forth above, the other methods may be applied, and information about the point cloud data classified as set forth above is saved in the storage unit 110 so as to be used for modeling the surface of land, the lay of the land, and the height of trees.

The modeling unit 140 may generate a digital surface model DSM and a digital terrain model DTM by inputting and receiving of the pointed cloud data that have been classified.

The digital surface model DSM is a model that records the point cloud data as a numerical value in order to represent the altitude of a surface on which artificial objects on the ground such as buildings, and forest vegetation such as trees are included.

The modeling unit 140 may generate the canopy height model CHM by using the digital surface model DSM and digital terrain model DTM with respect to the point cloud data corresponding to the trees classified by the pre-processing unit 130.

The canopy height model CHM is a model that records the height of the trees as a numerical value, and is able to calculate the height by subtracting the digital terrain model DTM from the digital surface model DSM. The canopy height model CHM may be used as a basis for classifying the canopy of the trees and determining whether or not the forest gap exists.

The information about the digital surface model DSM, the digital terrain model DTM, and the canopy height model CHM generated according to each point cloud datum is saved in the storage unit 110 so as to be used for classification of the canopy and detection of the forest gap.

The forest gap classification unit 150 classifies a region as a forest gap FG in the case that a total area of the region, in which a height of the canopy height model CHM is less than a first height H1, and in which the point cloud data are formed to be adjacent to each other, is more than a first area A1. On the one hand, it classifies the region as a closed canopy CC so as to be distinguished from the forest gap FG in the case that the total area of the region, in which the height of the canopy height model CHM is more than the first height H1, and in which the point cloud data are formed to be adjacent to each other, is less than the first area A1.

The first area Al may be an average of the minimum area of the forest gap occurring in an urban forest and may be 10 m², which is the average of the minimum area of the forest gap obtained through investigation and so on, and the first height H1 may be an average of the minimum height of trees, which grow in a lateral direction, and may be 5 m, which is a numerical value obtained through investigation and so on.

The forest gap change measurement unit 160 classifies a region as the forest gap FG or the closed canopy CC according to each day, month, year, or arbitrary time, thereby estimating a change compared to that shown at a point of time of earlier classification. The first measurement term T1 having a difference in time compared to that shown at the point of time of earlier classification may be two years to three years, but is not limited thereto.

In the case that the region classified as the closed canopy CC remains as the closed canopy even after the first measurement term T1 has passed, the region is continuously classified as the closed canopy CC, and in the case that the region changes to the forest gap FG, the region is classified as the forest gap FG.

In the case that the region classified as the forest gap FG changes to the closed canopy CC after the first measurement term T1 has passed, the region is classified as the closed gap CG, and in the case that the region still remains as the forest gap FG, the region is classified as an existing forest gap EG. Information about the aspects of the change, which have been classified, is provided to a user of the forest gap monitoring system 100 so that the change in the forest gap occurring in the urban forest can be monitored.

Meanwhile, in order to monitor the aspects of a change in a structure of the canopy according to [symbol] occurring in the forest gap, the forest gap monitoring system 100 may further comprise a canopy classification unit 170, a canopy change measurement unit 180, and an area classification unit 190.

With respect to the region of the point cloud data classified as the trees, the canopy classification unit 170 classifies the region as a lower canopy LC, which is lower forest vegetation, in the case that the height of the canopy height model is less than the first height H1 corresponding to the average of the minimum height of the trees, which grow in a lateral direction, and classifies the region as a higher canopy HC, which is upper forest vegetation, in the case that the height is more than the first height. By monitoring a change in the trees classified as above, in the case that the region of the trees changes from the lower canopy LC to the higher canopy HC, the region may be determined as a canopy closure area CaC, which is closed by growth of the trees.

The canopy change measurement unit 180 calculates the canopy height model of the point cloud data according to each day, month, year, or arbitrary time, thereby estimating a difference in the height compared to that shown at the point of time of earlier calculation. The canopy height model CHM may be calculated by subtraction of the digital terrain model DTM from the digital surface model DSM, and the second measurement term T2 having the difference in time compared to that shown at the point of time of earlier calculation may be two years to three years, but is not limited thereto.

The area classification unit 190 classifies the kind of the area, in which the canopy grows or is disturbed, by comparing the changes in the height of the canopy height model CHM according to each point cloud datum. In the case that the change in the height of the canopy height model CHM has a plus value, the area may be classified as a growth area GA in which the trees grow, and in the case that the change has a minus value, the area may be classified as a disturbance area DA in which the trees are being destroyed.

Furthermore, with respect to the region corresponding to the point cloud data determined as the growth area GA, the kind of the growth area GA is classified by comparing the changes in the height of the canopy height model CHM.

In the case that the height of the canopy height model CHM shows a change in the height, which is less than a second height H2, the region may be classified as a lateral growth area VG, and in the case that the height shows a change in the height, which is more than the second height H2, the region may be classified as a vertical growth area VG.

In the case that the trees grow in such a manner that the height of the canopy height model is more than the second height H2, the trees grow in a lateral direction as well as a vertical direction, in the case that the trees grow in such a manner that the height of the canopy height model is less than the second height H2, the trees grow only in a vertical direction, and the second height H2 may be 0.5 m, which is a numerical value obtained by investigation and so on.

In the case that the canopy of the trees classified by the canopy classification unit 170 changes from the lower canopy LC to the higher canopy HC, the region may be classified as a canopy closure area CaC.

The forest monitoring system 100 may further comprise an output unit 111 wherein the output unit 111 discriminates a lateral growth area LG, a vertical growth area VG, a disturbance area DA, a closed closure CaC, a closed canopy CC, a forest gap FG, a closed gap CG, and an existing forest gap EG from each other visually according to a color tone, a sign, and so on, thereby outputting information thereabout through an image display device or a printing device. This information about the urban forest classified by the output unit 111 may make a user of the forest gap monitoring system 100 easily recognize a change in the forest gap of the urban forest.

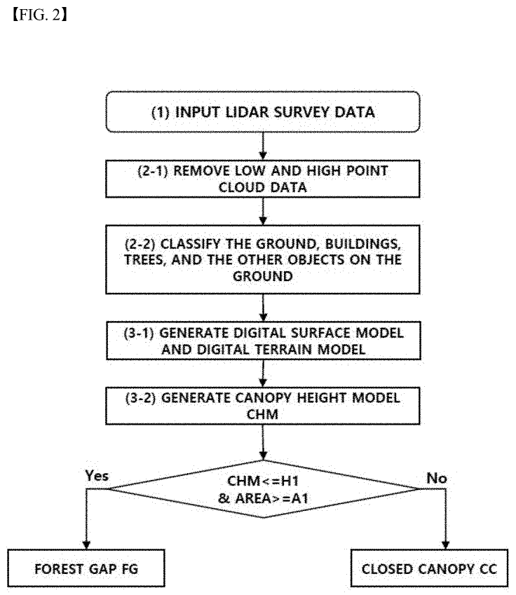

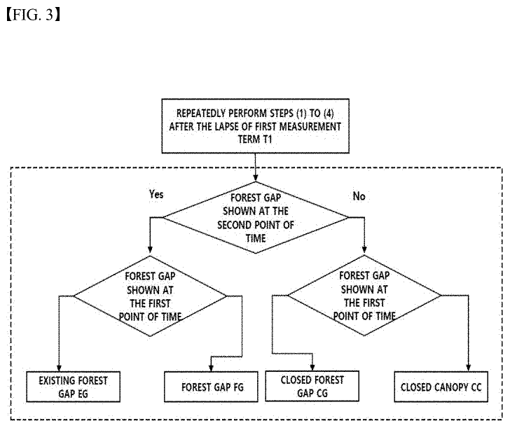

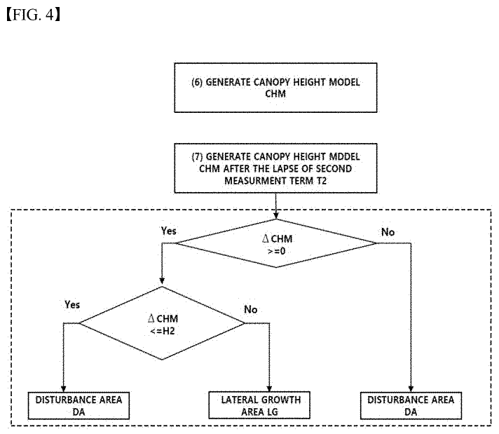

FIG. 2A is a view showing, by steps, a method of classifying a forest gap according to the present invention.

In a first step (1), a data input unit inputs and receives data including point cloud data from the outside, a survey of which is carried out by an aerial LiDAR or mobile LiDAR device.

In a second step (2), the pre-processing unit removes the low point cloud data and high point cloud data, which are noises, (see 2-1 of FIG. 2a), and determines and classifies each point cloud datum as the ground, buildings, trees, vehicles, and the other objects on the ground (see 2-2 of FIG. 2a).

In a third step (3), the modeling unit generates the digital surface model DSM and the digital terrain model DTM (see 3-1 of FIG. 2A), and generates the canopy height model CHM by subtracting a height of the digital terrain model DTM from a height of the digital surface model DSM (see 3-2 of FIG. 2A).

In a fourth step (4), the forest gap classification unit classifies a region as a forest gap FG in the case that a total area of the region corresponding to the adjacent point cloud data, in which a height of the canopy height model CHM is less than a first height H1 corresponding to an average of the minimum height at which the trees grow in a lateral direction, is more than a first area Al corresponding to an average area of the forest gap occurring in the urban forest, or classifies the region as a closed canopy CC in the case that the total area of the region, in which the height of the canopy height model is more than the first height, is less than the first area.

FIG. 2B is a view showing, by steps, a method of monitoring a change in the forest gap and classifying aspects of the change according to the present invention.

In a fifth step (5), the forest gap change measurement unit again performs the first to fourth steps at a second point of time when a first measurement term T1 has passed from a first point of time when the first to fourth steps were performed, thereby determining whether or not the investigated region is the forest gap FG.

In the case that the region classified as the forest gap FG at the second point of time was also classified as the forest gap FG at the first point of time before a lapse of the first measurement term T1, the region is classified as an existing forest gap EG, and in the case that the region was classified as the closed canopy, the region is classified as a closed forest gap CG.

In the case that the region classified as the closed canopy at the second point of time was classified as the forest gap FG at the first point of time before a lapse of the first measurement term T1, it is classified as a closed forest gap CG, and in the case that the region was classified as the closed canopy CC, it is continuously classified as the closed canopy CC.

Even though it is not shown in the drawings, information about the forest gap FG, the closed canopy CC, the existing forest gap EG, and the closed forest gap CG as set forth above is outputted on an image display device or a printing device by the output unit, and the change in the forest gap is visually displayed so that information about the aspects of the change in the forest gap occurring in the urban forest can be provided.

FIG. 2C is a view showing, by steps, a method of classifying the aspects of a change by monitoring the change in the canopy according to the present invention.

In a sixth step (6), the canopy classification unit classifies a canopy as the lower canopy LC in the case that the height of the canopy height model CHM is less than the first height H1, and as the higher canopy HC in the case that the height is more than the first height H1.

In a seventh step (7), the canopy change measurement unit again performs the sixth step at a fourth point of time when the second measurement term T2 has passed from a third point of time when the sixth step was performed, thereby measuring a change in the height of the canopy height model CHM.

In an eighth step, the area classification unit classifies an area as a disturbance area DA in the case that the change in the height of the canopy height model CHM has a plus value, as a vertical growth area VG in the case that the change is 0 or is shown as the second height H2, and as a lateral growth area LG in the case that the change is beyond the second height H2.

Even though it is not shown in the drawings, in the case that the trees change from a lower canopy to a higher canopy HC, the area may be determined as a closed closure area CaC, and information about the disturbance area DA, the vertical growth area VG, the later growth area LG, and the closed closure area Cac may be outputted on an image display device or a printing device by the output unit so that the change in the canopy can be visually displayed. Accordingly, information through which the growth of forest vegetation or a disturbance aspect occurring in the urban forest can be understood may be provided.

As set forth above, the present invention is not limited to the exemplary embodiments as above, but may be carried out with various modifications without departing from the purport of the present invention and hindering the effects.

What is claimed is:

1. A forest gap monitoring system comprising: a data input unit configured to input and receive LiDAR survey data including point cloud data; a pre-processing unit configured to remove low and high point cloud data from the LiDAR survey data and classify the point cloud data into the ground, buildings, trees, vehicles, and the other objects on the ground; a modeling unit configured to generate a digital surface model and a digital terrain model according to the each point cloud datum and generate a canopy height model by subtracting a height of the digital terrain model from a height of the digital surface model with respect to the point cloud data classified as the trees; a forest gap classification unit configured to classify a region as a forest gap in the case that a total area of the region corresponding to the adjacent point cloud data, in which a height of the canopy height model is less than a first height, is more than a first area, or classify the region as a closed canopy in the case that the total area of the region, in which the height of the canopy height model is more than the first height, is less than the first area; and a forest gap change measurement unit configured to classify the region as a closed forest gap in the case that the region classified as the forest gap changes to the closed canopy during a first measurement term, and classify the region as an existing forest gap in the case that the region classified as the forest gap remains as the forest gap.

2. The forest gap monitoring system of claim 1 further comprising: a canopy classification unit configured to classify a canopy as a lower canopy according to the each point cloud datum in the case that the height of the canopy height model is less than the first height, or classify the canopy as a higher canopy in the case that the height of the canopy height model is more than the first height; a canopy change measurement unit configured to measure a change in the height of the canopy height model according to the each point cloud datum during a second measurement term; and an area classification unit configured to classify an area as a vertical growth area according to the each point cloud datum in the case that a change in the height of the canopy height model has a plus value, and the height is less than a second height, classify the area as a lateral growth area in the case that the height is more than the second height, and classify the area as a disturbance area in the case that the change has a minus value.

3. The forest gap monitoring system of claim 1, wherein the first height is 5 m, the first area is 10 m², and the first measurement term is three years.

4. The forest gap monitoring system of claim 2, wherein the second height is 0.5 m, and the second measurement term is three years.

5. A forest gap monitoring method comprises: (1) inputting and receiving, by a data input unit, Lidar survey data including point cloud data; (2) removing, by a pre-processing unit, low and high point cloud data from the LiDAR survey data, and classifying each of the point cloud data into the ground, buildings, trees, vehicles, and the other objects on the ground; (3) generating, by a modeling unit, a digital surface model and a digital terrain model according to the each point cloud datum, and generating a canopy height model by subtracting a height of the digital terrain model from a height of the digital surface model with respect to the point cloud data classified as the trees; (4) classifying, by a forest gap classification unit, a region as a forest gap in the case that a total area of the region corresponding to the adjacent point cloud data, in which a height of the canopy height model is less than a first height, is more than a first area, or classifying the region as a closed canopy in the case that the total area of the region, in which the height of the canopy height model is more than a first height, is less than the first area; and (5) and classifying, by a forest gap change measurement unit, the region as a closed forest gap in the case that the region classified as the forest gap changes to the closed canopy during a first measurement term, and classifying the region as an existing forest gap in the case that the region classified as the forest gap remains as the forest gap.

6. The forest gap monitoring method of claim 5 further comprising: (6) classifying, by a canopy classification unit, a canopy as a lower canopy according to the each point cloud datum in the case that the height of the canopy height model is less than the first height, or classifying the canopy as a higher canopy in the case that the height of the canopy height model is more than the first height; (7) measuring, by a canopy change measurement unit, a change in the height of the canopy height model according to the each point cloud datum during a second measurement term; and (8) classifying, by an area classification unit, an area as a vertical growth area according to the each point cloud datum in the case that a change in the height of the canopy height model has a plus value, and the height is less than a second height, classifying the area as a lateral growth area in the case that the height is more than the second height, and classifying the area as a disturbance area in the case that

7. The forest gap monitoring method of claim 5, wherein the first height is 5 m, the first area is 10 m², and the first measurement term is three years.

8. The forest gap monitoring method of claim 6, wherein the second height is 0.5 m, and the second measurement term is three years.
